(19) United States
(12) Patent Application Publication
(10) Pub. No.: US 2020/0232811 A1
(43) Pub. Date: Jul. 23, 2020

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventors: Takashige HORI, Aisai-shi (JP); Naoto SASAGAWA, Nishio-shi (JP)

(73) Assignee: TOYOTA JIDOSHA KABUSHIKI KAISHA, Toyota-shi (JP)

(21) Appl. No.: 15/929,200

(22) Filed: Jan. 8, 2020

(30) Foreign Application Priority Data
Jan. 23, 2019 (JP) 2019-009754

(51) Int. Cl. G01C 21/36; G06Q 30/02

(52) U.S. Cl. CPC G01C 21/3682; G06Q 30/0259; G01C 21/3617; G01C 21/3641; G06Q 30/0242; G01C 21/3644

(57) ABSTRACT

An information processing device according to one embodiment of the present disclosure includes an advertising information delivery unit that causes a display device of a user terminal to display advertising information including navigation elements each of which guides the user to a predetermined action related to its content. An information processing device according to another embodiment of the present disclosure includes an advertising information display processing unit that causes a display device of a user terminal to display advertising information including navigation elements each of which guides the user to a predetermined action related to its content.

### INCORPORATION BY REFERENCE

The disclosure of Japanese Patent Application No. 2019-009754 filed on Jan. 23, 2019 including the specification, drawings and abstract is incorporated herein by reference in its entirety.

### BACKGROUND

### 1. Technical Field

The present disclosure relates to an information processing device, an information processing method, and a program.

### 2. Description of Related Art

A technique is known that acquires the information on the use of a coupon that is a piece of advertising information delivered, for example, as an email for viewing on a user terminal (for example, Japanese Patent Application Publication No. 2007-052749 (JP 2007 -052749 A)).

This technique makes it possible to know, from the information on the use of a coupon acquired as described above, whether the receiving user is interested in the coupon.

### SUMMARY

According to the technique described above, it is possible to determine whether the user is interested in a product or a service related to the delivered advertising information. However, it may be impossible to know whether the user has been interested in the advertising information until the time the user actually uses the coupon.

On the other hand, the information on whether pushed advertising information has been opened is notified by the user terminal shortly after the advertising information is delivered. However, it is uncertain whether the user has opened the advertising information with interest.

The present disclosure provides an information processing device, an information processing method, and a program that can accurately determine, at a relatively early time after the delivery of advertising information, whether the user is interested in the delivered advertising information.

One embodiment of the present disclosure provides an information processing device including a control unit configured to cause a display device of a user terminal to display advertising information that includes navigation elements. Each of the navigation elements guides a user to a predetermined action related to content thereof.

According to this embodiment, the information processing device can guide a user, who is interested in the advertising information, to a predetermined action on the user terminal, using the navigation elements included in the advertising information. This predetermined action is an action related to the content of the advertising information. Therefore, the information processing device can recognize whether a predetermined action has been performed through a navigation element, making it possible to determine more accurately whether the target user is interested in the advertising information at an earlier time after advertisement delivery.

In the embodiment described above, the navigation elements may include at least one of a first element, a second element, and a third element. The first element guides the user to schedule registration for a visit to a facility related to the advertising information using a scheduler function of the user terminal. The second element guides the user to routing assistance for assisting in routing to a facility related to the advertising information using a routing assistance function of the user terminal. The third element guides the user to browse a web page related to the advertising information using a browser function of the user terminal.

According to this embodiment, the information processing device allows the user to perform a specific action on the user terminal through a specific navigation element (first element to third element).

In the embodiment described above, the control unit may be configured to, when the second element corresponding to one piece of the advertising information is operated while the user is traveling to a predetermined destination: suggest the facility to the user through the user terminal as a waypoint when a facility related to the one piece of the advertising information is found around a travel route to the destination; and suggest another facility to the user through the user terminal as a waypoint when a facility related to the one piece of the advertising information is not found around the travel route, the other facility being located around the travel route and related to another piece of the advertising information whose genre is the same as or similar to the genre of the one piece of the advertising information.

According to this embodiment, when an operation on the navigation element (second element) for using the routing assistance function for a facility related to one piece of advertising information is performed, the information processing device can suggest a facility, located at an easy-to-access location while traveling to the destination and related to the advertising information, as a waypoint on the current travel route. In addition, even when a facility related to the one piece of advertising information is not found around the current travel route, the information processing device can suggest a facility, related to another piece of advertising information in which the user was interested in the past and whose genre is the same as or a similar to the genre of the one piece of advertising information, as a waypoint around the user's travel route. Therefore, the information processing device can improve user convenience.

In the embodiment described above, the control unit may be configured to, when the second element corresponding to one piece of the advertising information is operated while the user is traveling to the destination: suggest the facility to the user through the user terminal as a waypoint when a facility related to the one piece of the advertising information is found along the travel route; and suggest another facility to the user through the user terminal as a waypoint when a facility related to the one piece of the advertising information is not found along the travel route, the other facility being located along another travel route to the destination around the travel route and related to the one piece of the advertising information.

According to this embodiment, even when a facility related to the one piece of advertising information is not found along the current travel route when suggesting an advertisement related facility around the current travel route to the destination, the information processing device can suggest a facility located along another route around the travel route and related to the one piece of the advertising information. Therefore, the information processing device can further improve user convenience.

In the embodiment described above, the control unit may be configured to determine a facility related to the advertising information corresponding to at least one of the schedule registration and the routing assistance based on information on a travel history of the user.

According to this embodiment, the information processing device can recognize the user's past travel routes and the activity range based on the information on the user's travel history. Therefore, the information processing device can determine an advertisement information related facility corresponding to schedule registration or routing assistance, which is performed based on an operation on the navigation elements included in the advertising information, according to the user's travel routes and the activity range. Therefore, the information processing device can improve user convenience.

In the embodiment described above, the control unit may be configured to deliver to the user the advertising information to be displayed on the display device of the user terminal by a predetermined method.

According to this embodiment, the information processing device can cause the display device of the user terminal to display advertising information, in which the navigation elements are included, by delivering the advertising information to the user in a manner that the user can view it on the user terminal.

In the embodiment described above, the information processing device may further include a log information acquisition unit configured to acquire log information indicating whether the predetermined action has been performed by the user at the user terminal through the navigation elements.

According to this embodiment, the information processing device can specifically recognize whether a predetermined action has been performed by the user through a navigation element of the advertising information displayed on the user terminal.

In the embodiment described above, the information processing device may further include a verification unit configured to verify an effect of the delivery of the advertising information based on the log information acquired by the log information acquisition unit.

According to this embodiment, the information processing device can verify the effect of delivered advertising information by recognizing, based on the log information, whether each target user has performed a predetermined action through a navigation element.

Other embodiments of the present disclosure can be implemented as an information processing method and a program.

According to the embodiments described above, it is possible to provide the information processing device, the information processing method, and the program that can accurately determine, at a relatively early time after the delivery of advertising information, whether the user is interested in the delivered advertising information.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an example of a configuration of an advertisement delivery system;

FIG. 2 is a diagram showing an example of a hardware configuration of an advertisement delivery server;

FIG. 3 is a functional block diagram showing an example of a functional configuration of the advertisement delivery system;

FIG. 4A is a diagram showing an example of delivered advertising information displayed on the display device of a user terminal;

FIG. 4B is a diagram showing another example of delivered advertising information displayed on the display device of a user terminal;

FIG. 5 is a flowchart schematically showing an example of log information acquisition processing;

FIG. 6A is a diagram showing an example of a method for providing information on an advertisement related facility;

FIG. 6B is a diagram showing an example of a method for providing information on an advertisement related facility;

FIG. 6C is a diagram showing an example of a method for providing information on an advertisement related facility;

FIG. 6D is a diagram showing an example of a method for providing information on an advertisement related facility;

FIG. 6E is a diagram showing an example of a method for providing information on an advertisement related facility;

FIG. 7A is a diagram showing the operation of the advertisement delivery system in a comparative example; and

FIG. 7B is a diagram showing the operation of the advertisement delivery system in this embodiment.

### DETAILED DESCRIPTION OF EMBODIMENTS

Embodiments for carrying out the present disclosure will be described below with reference to the drawings.

### [Overview of Advertisement Delivery System]

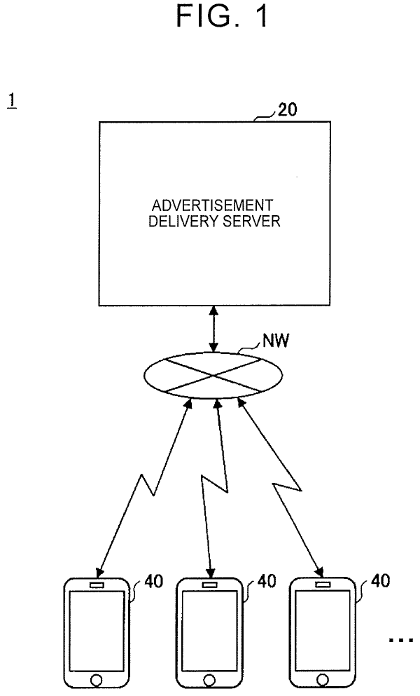

First, the overview of an advertisement delivery system 1 according to this embodiment will be described with reference to FIG. 1.

The advertisement delivery system 1 includes an advertisement delivery server 20 and a plurality of user terminals 40 corresponding to a plurality of users.

The advertisement delivery system 1 delivers advertising information from the advertisement delivery server 20 to the user terminals 40.

The advertisement delivery server 20 (an example of an information processing device) is communicably connected to each of the plurality of user terminals 40 through a communication network NW. The advertisement delivery server 20 receives, from an outside source, advertising information to be delivered and, at the same time, delivers the received advertising information to the user terminals 40 of target users who are included in the plurality of users and are relevant to the advertising information. The advertising information is, for example, coupon information related to goods purchase or service usage. Furthermore, the advertisement delivery server 20 acquires the log information, corresponding to the action history of the target users on the user terminals 40, from the user terminals 40 and verifies the effect of the delivery of the advertising information.

The user terminal 40 is a mobile terminal such as a smartphone, a mobile phone, a tablet terminal, and a laptop computer. The user terminal 40 may also be a stationary terminal such as a desktop computer.

The user terminal 40 is communicably connected to the advertisement delivery server 20 through the communication network NW. The user terminal 40 displays the advertising information, delivered from the advertisement delivery server 20, through a predetermined installed application program (hereinafter referred to as “advertising application”).

### [Configuration of Advertisement Delivery System]

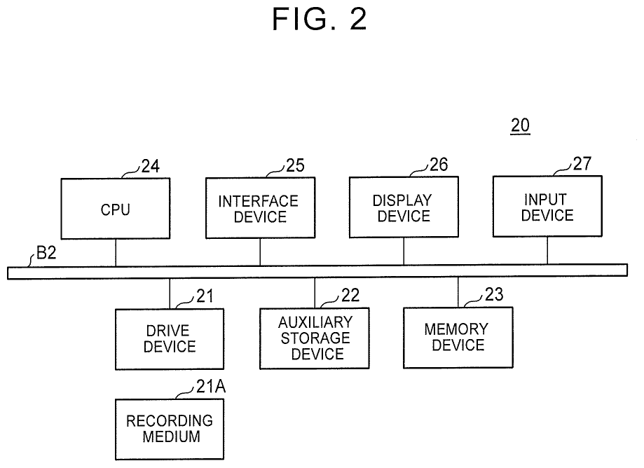

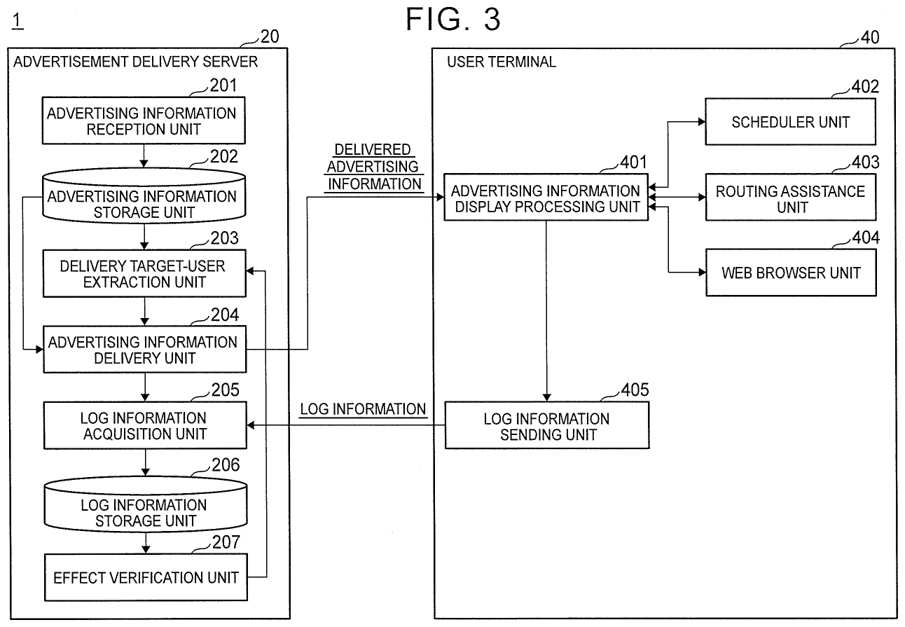

Next, a configuration of the advertisement delivery system 1 will be described with reference to FIG. 2 and FIG. 3 in addition to FIG. 1.

FIG. 2 is a diagram showing an example of a hardware configuration of the advertisement delivery system 1. More specifically, FIG. 2 is a diagram showing an example of a hardware configuration of the advertisement delivery server 20. FIG. 3 is a functional block diagram showing an example of a functional configuration of the advertisement delivery system 1.

Since a hardware configuration of the user terminal 40 is substantially the same as that of the advertisement delivery server 20, a hardware configuration of the user terminal 40 is not shown. In the description below, refer to FIG. 2 for a hardware configuration of the user terminal 40. In the description of the user terminal 40, reference numerals “21”, “21A”, “22”, “23”, “24”, “25”, “26”, “27”, and “B2” in FIG. 2 should be replaced with “41”, “41A”, “42”, “43”, “44”, “45”, “46”, “47”, and “B4”, respectively.

### <Configuration of Advertisement Delivery Server>

First, with reference to FIG. 2, a hardware configuration of the advertisement delivery server 20 will be described below. The function of the advertisement delivery server 20 may be implemented by any hardware or by a combination of hardware and software. As shown in FIG. 2, the advertisement delivery server 20 includes a drive device 21, an auxiliary storage device 22, a memory device 23, a CPU 24, an interface device 25, a display device 26, and an input device 27. These devices are interconnected by a bus B2.

The programs for implementing the various functions of the advertisement delivery server 20 are provided by a portable recording medium 21A such as a compact disc read only memory (CD-ROM), a digital versatile disc read only memory (DVD-ROM), and a universal serial bus (USB) memory. When the recording medium 21A, on which the programs are recorded, is set in the drive device 21, the programs are installed from the recording medium 21A to the auxiliary storage device 22 via the drive device 21. The programs may also be downloaded from another computer via a communication network for installation into the auxiliary storage device 22.

The auxiliary storage device 22 stores various programs that have been installed and the files and data that are necessary.

The memory device 23 reads a program from the auxiliary storage device 22 into itself (stores therein) when an instruction to start the program is received.

The CPU 24 executes various programs, stored in the memory device 23, to implement various functions related to the advertisement delivery server 20 according to the programs.

The interface device 25 is used as an interface for connecting to a communication network (for example, the communication network NW).

The display device 26 displays the graphical user interface (GUI), for example, according to a program executed by the CPU 24.

The input device 27 is used by the operator or manager of the advertisement delivery server 20 to enter various instructions to perform operations of the advertisement delivery server 20.

Next, with reference to FIG. 3, a functional configuration of the advertisement delivery server 20 will be described below. As shown in FIG. 3, the advertisement delivery server 20 includes the following functional units: an advertising information reception unit 201, a delivery target-user extraction unit 203, an advertising information delivery unit 204, a log information acquisition unit 205, and an effect verification unit 207. These functional units are implemented by executing one or more programs, installed in the auxiliary storage device 22, on the CPU 24. In addition, the advertisement delivery server 20 uses an advertising information storage unit 202 and a log information storage unit 206. The advertising information storage unit 202 may be implemented using, for example, the auxiliary storage device 22 or an external storage device that is communicably connected to the advertisement delivery server 20.

The advertising information reception unit 201 receives the advertising information to be delivered and the information accompanying the advertising information (accompanying information) from an outside source. The accompanying information includes the expiration date of the advertising information, the information on the target users, the information on the delivery time, and the like. The advertising information reception unit 201 stores the received advertising information and the accompanying information in the advertising information storage unit 202.

The advertising information storage unit 202 stores the advertising information and the accompanying information that are received by the advertising information reception unit 201. The advertising information and the accompanying information are stored with specific identification information assigned to them (hereinafter referred to as “advertisement identification information”).

For each piece of advertising information received by the advertising information reception unit 201, the delivery target-user extraction unit 203 extracts the target users of the advertising information from a plurality of users based on the accompanying information (information on target users). For example, the delivery target-user extraction unit 203 may extract the target users by comparing the requirement of the target users, predefined in advance for each piece of advertising information, with the attribute information on each of the plurality of users.

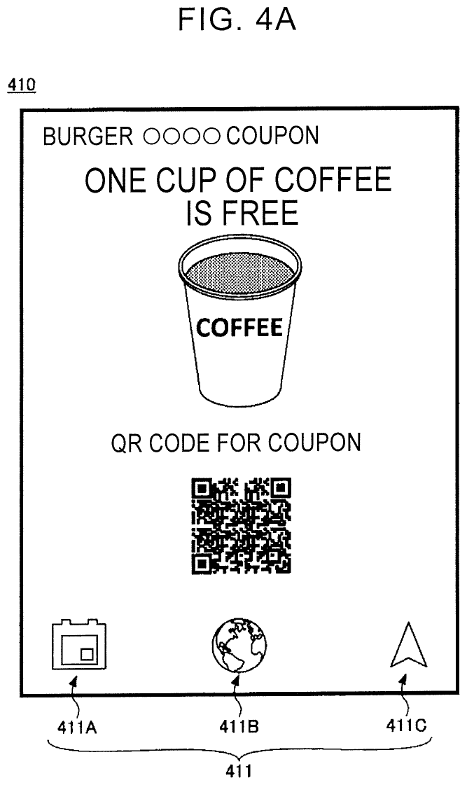

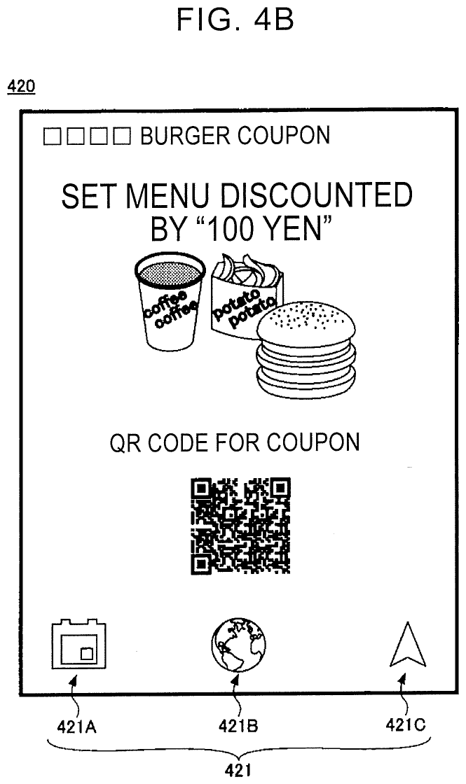

The advertising information delivery unit 204 (an example of a control unit) delivers each piece of advertising information (for example, pushes advertising information) to the user terminals 40 of the target users, extracted by the delivery target-user extraction unit 203, at a time predetermined for that advertising information. More specifically, based on the advertising information stored in the advertising information storage unit 202, the advertising information delivery unit 204 generates advertising information that includes navigation elements (hereinafter, such advertising information is referred to as “delivered advertising information”) and, then, delivers the generated advertising information to the user terminal 40 of each target user. Each of the navigation elements is an element that guides the user to a predetermined action, related to the content of the advertising information, on the user terminal 40. By doing so, the advertising information delivery unit 204 can cause the display device 46 of the user terminal 40 to display the delivered advertising information. The delivered advertising information may include at least one of the following three types of navigation elements. (1) an element (for example, schedule registration icons 411A and 421A that will be described later) that guides the user to register a schedule for visiting a facility related to the advertising information (hereinafter referred to as “advertisement related facility”). To implement this navigation element, the scheduler application (scheduler unit 402) of the user terminal 40 is used (hereinafter this element is referred to as “schedule registration guiding element”). (2) an element (for example, routing assistance icons 411C and 421C that will be described later) that guides the user to the assistance of routing to an advertisement related facility. To implement this navigation element, the routing assistance application of the user terminal 40 is used (hereinafter this element is referred to as “routing assistance guiding element”). (3) an element (for example, web browsing icons 411B and 421B that will be described later) that guides the user to browse a web page related to the advertising information. To implement this navigation element, the browser function (web browser unit 404) of the user terminal 40 is used (hereinafter this element is referred to as “web browsing guiding element”). The detail of advertising information that includes the navigation elements (delivered advertising information) will be described later (see FIG. 4A and FIG. 4B).

The processing for including a navigation element into the advertising information may be performed by the user terminal 40 (an example of information processing device) (for example, an advertising information display processing unit 401 (an example of a control unit), which will be described later, may perform this processing).

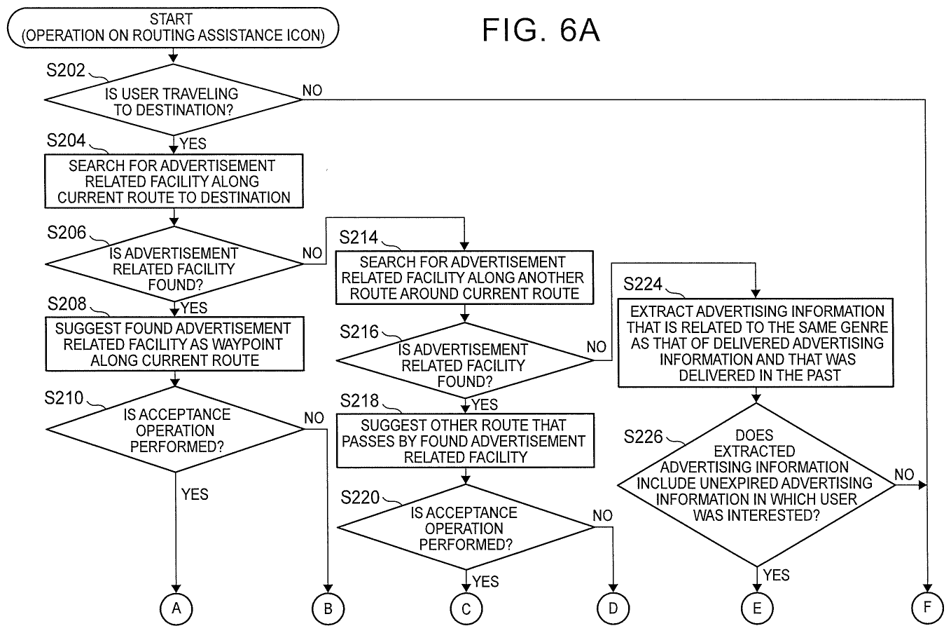

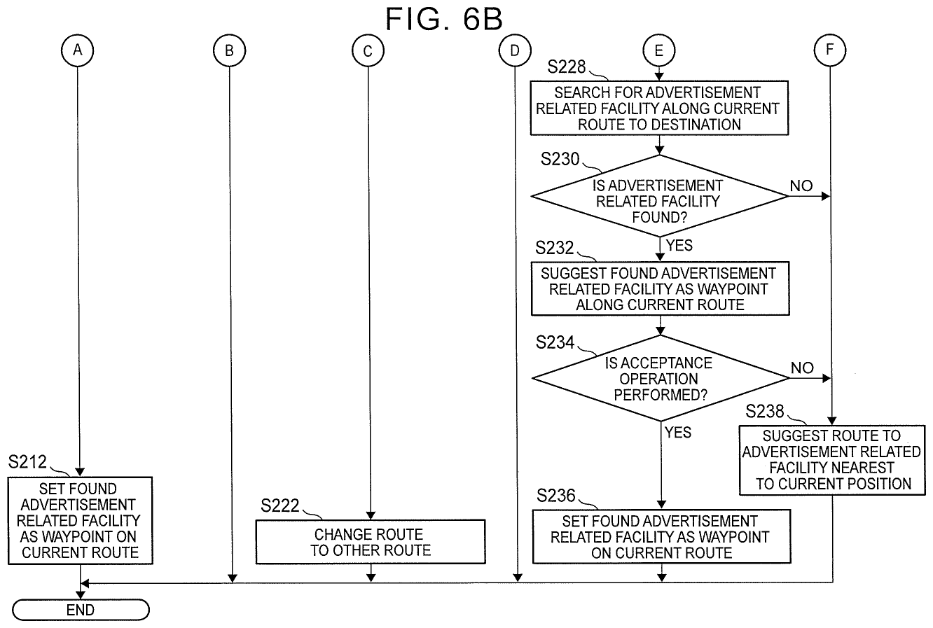

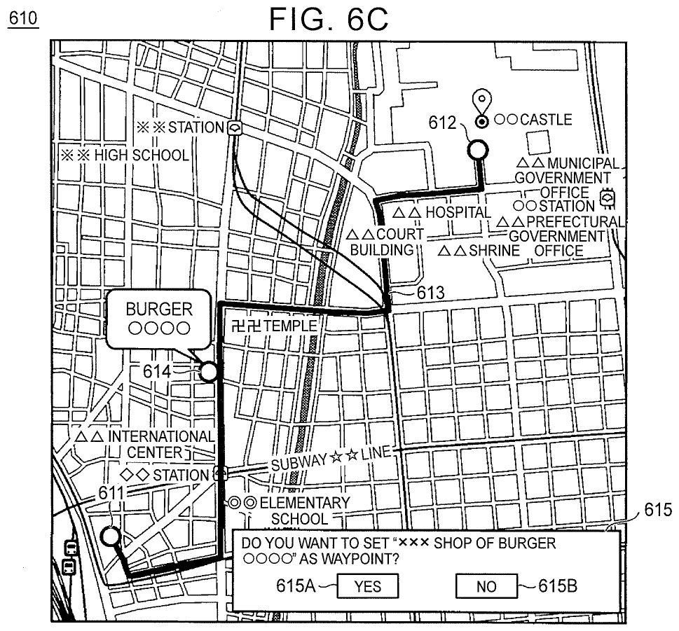

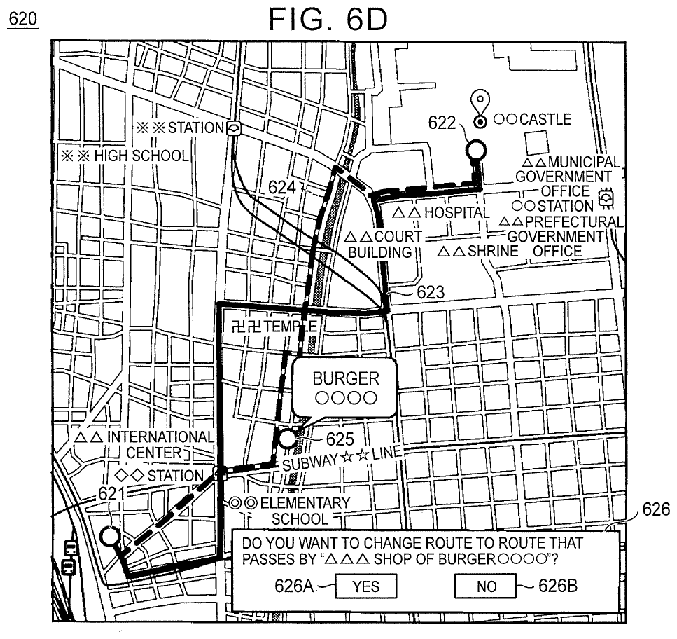

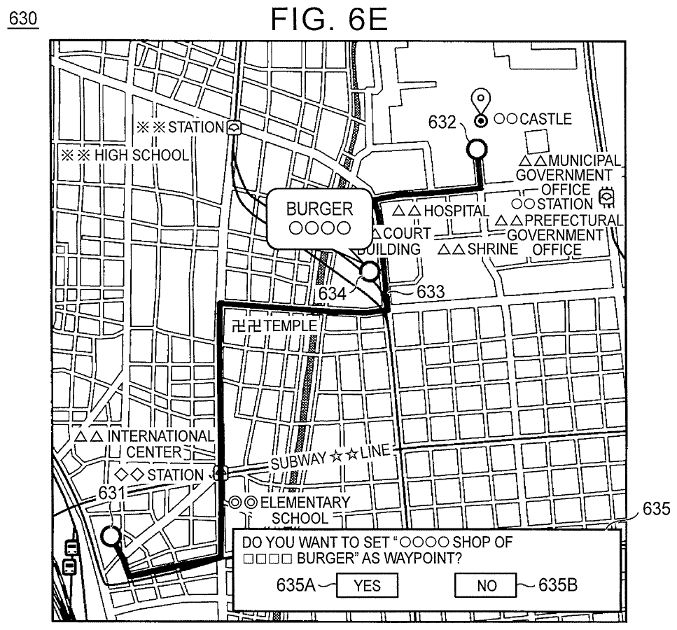

The advertising information delivery unit 204 may control the operation of the advertising application based on a user's operation on a navigation element of delivered advertising information displayed on the user terminal 40. The detail will be described later (see FIG. 6A to FIG. 6E).

The log information acquisition unit 205 acquires log information from the user terminals 40. This log information indicates whether a predetermined action has been performed on the user terminal 40 by the user through a navigation element included in the delivered advertising information (that is, whether the user has been guided to a predetermined action). As a result, when the log information indicates that the user has performed a predetermined action through a navigation element included in the delivered advertising information, the effect verification unit 207 can determine that the user is interested in the delivered advertising information. The log information acquisition unit 205 associates the acquired log information with the user identification information (for example, user ID (identifier) of each of a plurality of users) corresponding to the user terminal 40 from which the log information is received (hereinafter this information is called user identification information) and with the advertisement identification information corresponding to the log information and stores the associated information in the log information storage unit 206. When the log information is stored in this way, the effect verification unit 207 can identify delivered advertising information corresponding to the log information based on the advertisement identification information and, at the same time, can identify a user corresponding to the log information based on the user identification information.

The log information storage unit 206 stores the log information associated with the advertisement identification information and the user identification information. The log information storage unit 206 holds, for example, a group of records (that is, a database) that includes the advertisement identification information, user identification information, and log information.

Note that the functions of the log information acquisition unit 205 and the log information storage unit 206 may be transferred to another server device other than the advertisement delivery server 20.

The effect verification unit 207 (an example of a verification unit) verifies, for each piece of advertising information, the effect of the delivered advertising information, which has been delivered, based on the log information stored in the log information storage unit 206. For example, based on the log information, the effect verification unit 207 extracts users who are target users and are interested in the advertising information. The users extracted in this way are referenced by the delivery target-user extraction unit 203. As a result, the delivery target-user extraction unit 203 can extract the users, who are interested in the advertising information, as the users to whom the related advertising information of a certain piece of advertising information is to be delivered (for example, upgraded coupon information provided by the same advertiser). This allows the related advertising information to be further provided to a user who is interested in a certain piece of advertising information, improving the effect of the advertising information. Furthermore, the effect verification unit 207 may perform the statistical processing on the interested users based on the log information stored in the log information storage unit 206. This allows the effect verification unit 207 to statistically verify the effect of the advertising information.

Note that the function of the effect verification unit 207 may be transferred to another server device other than the advertisement delivery server 20. When the function of the effect verification unit 207 is transferred to another server device, the functions of the log information acquisition unit 205, the log information storage unit 206, and the effect verification unit 207 may be transferred to the same server device.

### <Configuration of User Terminal>

Like the advertisement delivery server 20, the function of the user terminal 40 may be implemented by any hardware or by a combination of hardware and software. As shown in FIG. 2, the user terminal 40 includes a drive device 41, an auxiliary storage device 42, a memory device 43, a CPU 44, an interface device 45, a display device 46, and an input device 47. These devices are interconnected by the bus B4.

Since a hardware configuration of the user terminal 40 is substantially the same as a hardware configuration of the advertisement delivery server 20, the detailed description is omitted.

Next, with reference to FIG. 3, a functional configuration of the user terminal 40 will be described. As shown in FIG. 3, the user terminal 40 includes the following functional units: an advertising information display processing unit 401, a web browser unit 404, and a log information sending unit 405. These functional units are implemented by executing the advertising application, installed in the auxiliary storage device 42, on the CPU 44. The user terminal 40 further includes the following functional units: scheduler unit 402 and a routing assistance unit 403. These functional unit are implemented by executing an application program related to the scheduler function (hereinafter referred to as “scheduler application”) and an application program related to the routing assistance function (hereinafter referred to as “routing assistance application”), installed in the auxiliary storage device 42, on the CPU 44, respectively. The advertising application is configured to be able to perform its operation in cooperation with the routing assistance application and the scheduler application.

The advertising information display processing unit 401 causes the display device 46 to display delivered advertising information that is pushed by the advertisement delivery server 20. More specifically, when delivered advertising information is received from the advertisement delivery server 20, the advertising information display processing unit 401 causes the display device 46 to display a push notification indicating that the latest delivered advertising information has been delivered. This latest delivered advertising information includes the summary information on the delivered advertising information (for example, the name of the advertiser and the genre to which the business belongs). After that, when an operation for opening the delivered advertising information is performed through the input device 47, the advertising information display processing unit 401 causes the display device 46 to display the delivered advertising information. In this way, this configuration allows the user to display the delivered advertising information on the display device 46 only when the user is interested in the summary information.

The scheduler unit 402 registers a user's schedule, which includes the date/time and the content of the schedule, in the schedule database, or causes the display device 46 to display a registered schedule to allow the user to confirm it, when the user performs an operation through the input device 47. Note that the user's schedule database may be built in the user terminal 40 or may be built in a server on the cloud so that the contents of the schedule database can be confirmed from other user terminals.

The routing assistance unit 403 searches for a predetermined facility (facility search function) or searches for a route from a predetermined starting point to a predetermined destination (route search function) and presents a searched-for route as the search result. Since the routing assistance unit 403 has the functions described above, the facility that has been searched for by the facility search function may be specified as the starting point or the destination in performing the route search.

The web browser unit 404 causes the display device 46 to display the information on a specified web page.

Note that the function of the web browser unit 404 may be implemented by an application program other than the advertising application, for example, by a dedicated browser application for browsing web pages. In this case, the advertising application is configured to be able to perform its operation in cooperation with the browser application.

The log information sending unit 405 (an example of a log information acquisition unit) acquires the history of operations, performed by the user through the input device 47, to acquire the log information. The log information indicates whether a user's predetermined action was performed through a navigation element included in the delivered advertising information. After that, the log information sending unit 405 uploads (sends) the acquired log information to the advertisement delivery server 20. The detail will be described later (see FIGS. 6A to 6E).

### [Example of Delivered Advertising Information]

Next, an example of delivered advertising information will be described with reference to FIG. 4A and FIG. 4B.

FIG. 4A is a diagram showing an example of delivered advertising information (delivered advertising information 410), and FIG. 4B is a diagram showing another example of delivered advertising information (delivered advertising information 420), displayed on the display device 46. More specifically, FIG. 4A shows the coupon information for “Burger ○○○○” indicating that a cup of coffee is free, and FIG. 4B shows the coupon information for “□□□□Burger” indicating that a set of a hamburger, fried potatoes, and a soft drink is discounted by 100 yen.

As shown in FIG. 4A and FIG. 4B, a navigation element 411 is included in the delivered advertising information 410, and a navigation element 421 in the delivered advertising information 420.

The navigation elements 411 include a schedule registration icon 411A, a web browsing icon 411B, and a routing assistance icon 411C, while the navigation elements 421 include a schedule registration icon 421A, a web browsing icon 421B, and a routing assistance icon 421C. Since the navigation elements 411 and 421 have the same function, the navigation elements 411 will be mainly described below.

The schedule registration icon 411A (an example of a first element) is a virtual icon that, when operated, starts the scheduler application (scheduler unit 402) for allowing the user to register a schedule for visiting a facility related to the delivered advertising information 410 (more specifically, the shop of “Burger ○○○○”). That is, the schedule registration icon 411A guides the user to the registration of a schedule for a visit to the facility related to the delivered advertising information 410.

When the schedule registration icon 411A is operated through the input device 47, the scheduler unit 402 causes the display device 46 to display the operation screen (hereinafter referred to as “schedule registration screen”), which is used for registering a schedule for a visit to the shop of “Burger ○○○○”, in response to a request from the advertising application. When the user is interested in the content of the delivered advertising information 410, displaying the schedule registration screen in this way allows the user to skip the operation to temporarily close the application screen related to the advertising application and then to start the scheduler application himself or herself, thus improving convenience. At this time, in the content (name) field of the schedule on the schedule registration screen, the character information indicating that the user will visit the shop of “Burger ○○○○” has already been entered. This eliminates the need for the user to enter the name of the schedule when registering the schedule, further improving convenience. In addition, the shop to be registered in the schedule may be identified or does not need to be identified. When identified, the shop to be registered may be a shop nearest to the user's current position determined by the position information acquired by the global positioning satellite system (GNSS) module built in the user terminal 40, determined by the Internet Protocol (IP) address information, or determined by the base station information. Furthermore, the shop to be registered may be identified by the user's travel history based on the position information acquired by the GNSS module built in the user terminal 40 or acquired by the base station information. More specifically, based on the user's travel history, the shop frequently visited by the user or the shop along the road link that is frequently used by the user may be identified. Identifying the shop in this way allows the schedule registration screen to be filled automatically with the information of the shop frequently visited by the user or with the name of the shop located along the road link frequently used by the user, further improving user convenience. The same applies to a shop that is determined by routing assistance that is started when the routing assistance icon 411C, which will be described later, is operated.

The web browsing icon 411B (an example of a third element) is a virtual icon that, when operated, starts the web browser unit 404 for allowing the user to browse a web page related to the delivered advertising information. That is, the web browsing icon 411B guides the user to the browsing of a web page related to the delivered advertising information.

When the web browsing icon 411B is operated through the input device 47, the web browser unit 404 displays, for example, the homepage of “Burger ○○○○”. At this time, the web browser unit 404 may display the top page or display the web page of the menu or services related to the delivered advertising information. Displaying the web page in this way allows the user to confirm the detailed information on the delivered advertising information 410. In addition, when the user is interested in the content of the delivered advertising information 410, displaying the web page in this way allows the user to skip the operation to temporarily close the application screen related to the advertising application and then to start the browser application himself or herself, thus improving convenience.

The routing assistance icon 411C (an example of a second element) is a virtual icon that, when operated, starts the routing assistance application for guiding the user to a facility related to the delivered advertising information 410 (more specifically, to the shop of “Burger ○○○○”). That is, the routing assistance icon 411C guides the user to the assistance of routing to the facility related to the delivered advertising information 410.

When the routing assistance icon 411C is operated through the input device 47, the routing assistance unit 403 searches for a route to the shop of “Burger ○○○○” in response to a request from the advertising application. After that, the routing assistance unit 403 causes the display device 46 to display the searched-for route as the search result. When the user is interested in the content of the delivered advertising information 410, displaying the search result in this way allows the user to skip the operation to temporarily close the application screen related to the advertising application and then to start the routing assistance application himself or herself, thus improving user convenience.

### [Log Information Acquisition Method]

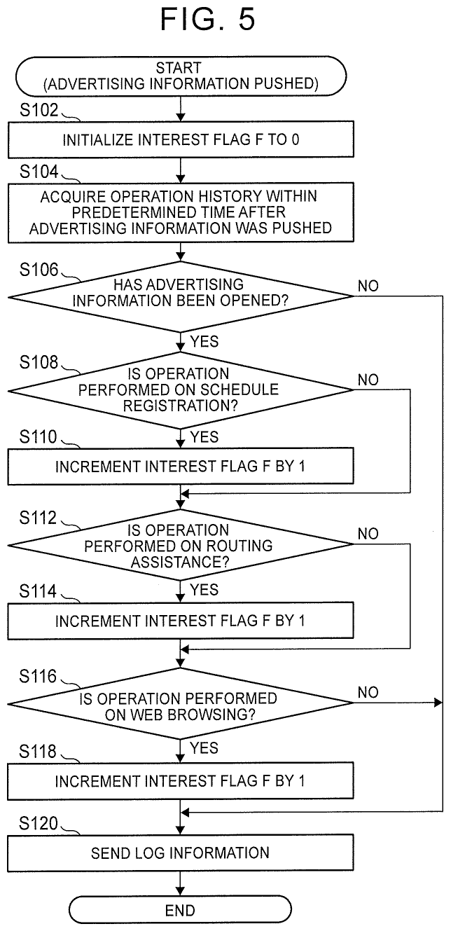

Next, the log information acquisition method will be described with reference to FIG. 5.

FIG. 5 is a flowchart schematically showing an example of the log information acquisition processing performed by the log information sending unit 405 of the user terminal 40.

As shown in FIG. 5, the log information sending unit 405 initializes the interest flag F to “0” in step S102, and the processing proceeds to step S104. The interest flag F indicates whether the user is interested in the delivered advertising information and the degree of user's interest in the delivered advertising information. More specifically, the interest flag F “0” indicates that the user is not interested in the delivered advertising information. The interest flag F “1” to “3” indicates that the user is interested in the delivered advertising information with a higher value indicating a higher degree of user's interest.

In step S104, the log information sending unit 405 acquires the operation history of the user terminal 40 within a predetermined time (for example, within a few minutes) after the delivered advertising information, about which the log information is to be acquired, was pushed, and the processing proceeds to step S106.

In step S106, the log information sending unit 405 determines whether the delivered advertising information, about which the log information is to be acquired, has been opened. When the delivered advertising information has been opened, the processing proceeds to step S108; otherwise, the processing proceeds to step S120.

In step S108, the log information sending unit 405 determines whether the user has performed an operation on the schedule registration guiding element included in the delivered advertising information. When the user has performed an operation on the schedule registration guiding element, the processing proceeds to step S110; otherwise, the processing proceeds to step S112.

In step S110, the log information sending unit 405 increments (increases) the interest flag F by 1, and the processing proceeds to step S112.

In step S112, the log information sending unit 405 determines whether the user has performed an operation on the routing assistance guiding element included in the delivered advertising information. When the user has performed an operation on the routing assistance guiding element, the processing of the log information sending unit 405 proceeds to step S114; otherwise, the processing proceeds to step S116.

In step S114, the log information sending unit 405 increments (increases) the interest flag F by 1, and the processing proceeds to step S116.

In step S116, the log information sending unit 405 determines whether the user has performed an operation on the web browsing guiding element included in the delivered advertising information. When the user has performed an operation on the web browsing guiding element, the processing of the log information sending unit 405 proceeds to step S118; otherwise, the processing proceeds to step S120.

In step S118, the log information sending unit 405 increments (increases) the interest flag F by 1, and the processing proceeds to step S120.

In step S120, the log information sending unit 405 generates (acquires) the log information that includes the interest flag F, and sends the generated log information to the advertisement delivery server 20. As a result, the advertisement delivery server 20 can acquire the log information indicating whether the user has performed an operation on at least one of the navigation elements included in the delivered advertising information. Therefore, the effect verification unit 207 of the advertisement delivery server 20 can recognize whether the user is interested in the advertising information and the degree of user's interest in the advertising information based on the interest flag F included in the log information.

### [Method for Providing Information on a Facility Related to Advertising Information]

Next, an example of the method for providing information on an advertisement related facility will be described with reference to FIG. 6A to FIG. 6E.

FIG. 6A to FIG. 6E are diagrams showing an example of the method performed by the advertisement delivery system 1 for providing information on an advertisement related facility. More specifically, FIG. 6A and FIG. 6B are flowcharts schematically showing an example of the assistance of routing to an advertisement related facility performed by the user terminal 40. The processing of this flowchart is executed, for example, when the user performs an operation on the routing assistance element included in delivered advertising information displayed on the display device 46. FIG. 6C to FIG. 6E are diagrams showing the examples of the routing assistance screen (routing assistance screens 610 to 630) displayed on the display device 46 of the user terminal 40.

The routing assistance processing in FIG. 6A and FIG. 6B may be executed autonomously by the user terminal 40 or may be executed by the user terminal 40 under the control of the advertisement delivery server 20 in response to a command that is output from the advertisement delivery server 20 (for example, the advertising information delivery unit 204) to the user terminal 40. In the latter case, the information on the user's operation state and on the display state of the display device 46 is sequentially sent from the user terminal 40 to the advertisement delivery server 20 to allow the advertisement delivery server 20 to send the command to the user terminal 40 as appropriate.

The processing according to the flowcharts in FIG. 6A and FIG. 6B will be described below with focus on the processing performed when the user performs an operation on the routing assistance icon 411C in FIG. 4A.

In step S202, the advertising information display processing unit 401 determines whether the user is traveling to a predetermined destination, as shown in FIG. 6A. For example, the advertising information display processing unit 401 may make this determination by checking whether the user is using the routing assistance function to route to the destination that is set by the routing assistance application. In addition, when the user is in the vehicle, the advertising information display processing unit 401 may make this determination, for example, by performing a predetermined short-range communication (for example, Bluetooth (registered trademark) communication) with the navigation device of the vehicle to confirm whether routing assistance to route to the destination is being executed by the navigation device. In addition, the advertising information display processing unit 401 may make this determination by comparing the user's past travel history with the user's current travel state to determine whether the user is traveling to a place where the user has been there in the past. At this time, the user's past travel history and the user's current travel state may be recognized based, for example, on the position information acquired by the GNSS module of the user terminal 40 that works as a mobile terminal. When the user is traveling to a predetermined destination, the processing of the advertising information display processing unit 401 proceeds to step S204; otherwise, the processing proceeds to step S238.

In step S204, the routing assistance unit 403 searches for an advertisement related facility along the current route to the destination under the control of the advertising application (advertising information display processing unit 401). In the following steps in this flowchart, the routing assistance unit 403 performs its operation in cooperation with the advertising application under the control of the advertising information display processing unit 401.

In step S206, the routing assistance unit 403 determines whether an advertisement related facility is found along the current route to the destination. When an advertisement related facility is found along the current route to the destination, the processing of the routing assistance unit 403 proceeds to step S208; otherwise, the processing proceeds to step S214.

In step S208, the routing assistance unit 403 suggests the found advertisement related facility as a waypoint along the current route on the routing assistance screen.

For example, on the routing assistance screen 610, a shop 614 of “Burger ○○○○” is displayed along a current route 613 from a starting point 611 to a destination 612 as shown in FIG. 6C. In addition, at the bottom of the routing assistance screen 610, a pop-up 615 is displayed for suggesting the shop 614 of “Burger ○○○○” as a waypoint along the current route. The user can operate an acceptance icon 615A in the pop-up 615 through the input device 47 to set the shop 614 as a waypoint. The user can also operate a rejection icon 615B in the pop-up 615 to reject the setting of the shop 614 as a waypoint.

Returning to FIG. 6A, the routing assistance unit 403 determines in step S210 whether the user has performed the acceptance operation for the suggestion that was made in step S208. When the user has performed the acceptance operation, the processing of the routing assistance unit 403 proceeds to step S212; when the user has not performed the acceptance operation, that is, when the user has performed the rejection operation, the routing assistance unit 403 terminates the processing.

In step S212, the routing assistance unit 403 sets the advertisement related facility, found along the current route, as a waypoint on the current route as shown in FIG. 6B and, then, terminates the current processing. As a result, the routing assistance unit 403 starts routing assistance from the current position to the waypoint (advertisement related facility) along the current route on the routing assistance screen.

On the other hand, in step S214, the routing assistance unit 403 searches for an advertisement related facility along another route to the destination around the current route as shown in FIG. 6A. In this case, the other route to the destination around the current route may be determined in such a way that the delay from the time the user would arrive at the destination along the current route is relatively small (for example, a delay within a maximum of 10 minutes).

In step S216, the routing assistance unit 403 determines whether an advertisement related facility is found along the other route to the destination that is around the current route. When an advertisement related facility is found along the other route to the destination that is around the current route, the processing of the routing assistance unit 403 proceeds to step S218; otherwise, the processing proceeds to step S224.

In step S218, on the routing assistance screen, the routing assistance unit 403 suggests the other route that passes by the found advertisement related facility.

For example, a shop 625 of “Burger ○○○○” is displayed on a routing assistance screen 620 as shown in FIG. 6D. This burger shop is located along another route 624 that is a route from a starting point 621 to a destination 622 and is around a current route 623. In addition, at the bottom of the routing assistance screen 620, a pop-up 626 is displayed for suggesting that the route is to be changed to the other route 624 that passes by the shop 625 of “Burger ○○○○”. The user can operate an acceptance icon 626A in the pop-up 626 through the input device 47 to change the route to the other route 624 that passes by the shop 625. On the other hand, the user can operate a rejection icon 626B in the pop-up 626 to reject the change in the route to the other route 624.

In step S220, the routing assistance unit 403 determines whether the user has performed the acceptance operation for the suggestion that was made in step S218. When the user has performed the acceptance operation, the processing of the routing assistance unit 403 proceeds to step S222; when the user has not performed the acceptance operation, that is, when the user has performed the rejection operation, the routing assistance unit 403 terminates the current processing.

In step S222, the routing assistance unit 403 changes the route to the other route that is found and that passes by the advertisement related facility and, at the same time, sets the advertisement related facility as a waypoint as shown in FIG. 6B . Then, the routing assistance unit 403 terminates the current processing. As a result, on the routing assistance screen, the routing assistance unit 403 starts routing assistance from the current position to the waypoint (advertisement related facility) along the other route.

On the other hand, in step S224, the advertising information display processing unit 401 extracts the delivered advertising information whose genre is the same as that of the currently delivered advertising information and that was delivered in the past but is not yet expired, as shown in FIG. 6A. For example, when the currently delivered advertising information is related to the provision of a hamburger as shown in FIG. 4A, the advertising information display processing unit 401 extracts the delivered advertising information that belongs to the same genre (provision of a hamburger) and that was delivered in the past but is not yet expired (for example, delivered advertising information 420 in FIG. 4B). At this time, the advertising information display processing unit 401 may request the advertisement delivery server 20 to extract the information, or the advertising information display processing unit 401 itself may extract the information from the history (log) of the delivered advertising information that was pushed to the user terminal 40 but is not yet expired.

In this step, the advertising information display processing unit 401 may extract the information not only in the same genre but also in a similar genre. For example, when the currently delivered advertising-information is related to the provision of a hamburger as shown in FIG. 4A, the advertising information display processing unit 401 may extract the delivered advertising information that is related to the provision of other types of fast food similar to a hamburger and that was delivered in the past but is not yet expired.

In step S226, the advertising information display processing unit 401 determines whether the delivered advertising information extracted in step S224 includes the delivered advertising information in which the user was interested. More specifically, the advertising information display processing unit 401 may make this determination by recognizing whether the user was interested in the extracted past delivered advertising information based on the log information corresponding to the extracted past advertising information. When the extracted information includes the delivered advertising information in which the user was interested, the processing of the advertising information display processing unit 401 proceeds to step S228. When the extracted information does not include the advertising information in which the user was interested, the advertising information display processing unit 401 terminates the current processing.

Note that the processing in this step may be omitted. In other words, regardless of whether or not the user was interested, the processing in step S228 and the subsequent steps, which will be described below, may be performed for the past delivered advertising information extracted in step S224.

In step S228, the routing assistance unit 403 searches for an advertisement related facility located along the current route to the destination and corresponding to the past delivered advertising information in which the user was interested, as shown in FIG. 6B. Then, the processing proceeds to step S230.

In step S230, the routing assistance unit 403 determines whether an advertisement related facility located along the current route to the destination and corresponding to the past delivered advertising information in which the user was interested is found. When such an advertisement related facility is found along the current route to the destination, the processing of the routing assistance unit 403 proceeds to step S232; when such an advertisement related facility is not found, the routing assistance unit 403 terminates the current processing.

When an advertisement related facility located along the current route to the destination and corresponding to the past delivered advertising information in which the user was interested is not found, the routing assistance unit 403 may search not only the current route but also another route around the current route for an advertisement related facility again as in step S214. When such an advertisement related facility is found, the same processing similar to that in step S218 to step S222 is executed. On the other hand, when such an advertisement related facility is not found, the routing assistance unit 403 may terminate the current processing.

In step S232, on the routing assistance screen, the routing assistance unit 403 suggests the advertisement related facility corresponding to the past delivered advertising information, in which the user was interested, as a waypoint along the current route.

For example, a shop 634 of “□□□□ Burger” is displayed on the routing assistance screen 630 as shown in FIG. 6E. This shop 634 of “□□□□ Burger” is located along the current route 633 from a starting point 631 to a destination 632 and corresponds to the delivered advertising information 420 in FIG. 4B whose genre is the same as that of the delivered advertising information 410 in FIG. 4A. At the bottom of the routing assistance screen 630, a pop-up 635 is displayed for suggesting the shop 634 of “□□□□ Burger” as a waypoint along the current route. The user can operate an acceptance icon 635A in the pop-up 635 through the input device 47 to set the shop 634 as a waypoint. The user can also operate the rejection icon 635B in the pop-up 635 to reject the setting of the shop 634 as a waypoint.

Returning to FIG. 6B, in step S234, the routing assistance unit 403 determines whether the user's acceptance operation is performed for the suggestion in step S232. When the acceptance operation is performed, the processing of the routing assistance unit 403 proceeds to step S236. When the acceptance operation is not performed, that is, when the rejection operation is performed, the routing assistance unit 403 terminates the current processing.

In step S236, the routing assistance unit 403 sets, as a waypoint on the current route, the advertisement related facility that is found along the current route and that corresponds to the past delivered advertising information and, then, terminates the current processing. After that, on the routing assistance screen, the routing assistance unit 403 starts routing assistance from the current position to the waypoint (advertisement related facility corresponding to the past delivered advertising information) along the current route.

On the other hand, in step S238, the routing assistance unit 403 suggests a route to the advertisement related facility that corresponds to the currently delivered advertising information and that is nearest to the user's current position and, then, terminates the current processing.

In this step, the routing assistance unit 403 may select an advertisement related facility, for which routing assistance information is to be provided, with consideration for the user's past travel history as described above.

### [Operation of the Embodiment]

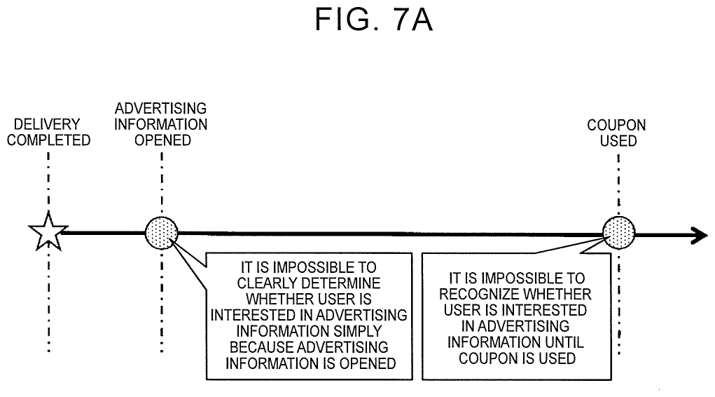

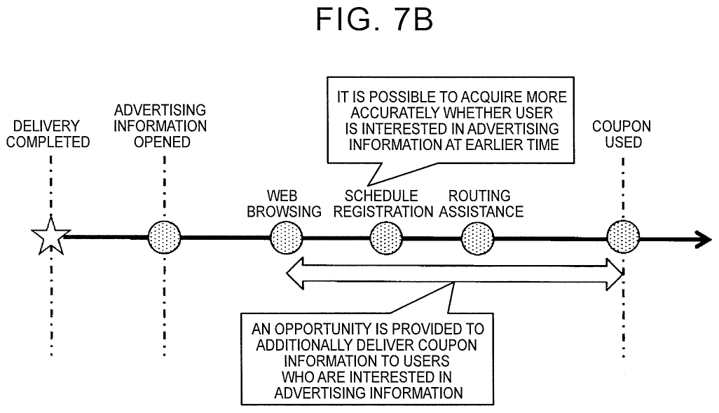

Next, the operation of the advertisement delivery system 1 according to the embodiment will be described with reference to FIG. 7A and FIG. 7B.

FIG. 7A is a diagram showing the behavior of a user that the user will perform for advertising information delivered by the advertisement delivery system in a comparative example. FIG. 7B is a diagram showing the behavior of a user that the user will perform for advertising information (delivered advertising information) delivered by the advertisement delivery system 1 in this embodiment.

In this embodiment, the advertising information delivery unit 204 (advertising information display processing unit 401) causes the display device 46 of the user terminal 40 to display advertising information that includes the navigation elements. Each of the navigation elements guides the user to a predetermined action related to the content of the navigation element.

The navigation elements included in the advertising information in this way enable the advertisement delivery server 20 (user terminal 40) to guide a user, who is interested in the advertising information, to a predetermined action on the user terminal 40. This predetermined action is an action related to the content of the advertising information. Therefore, the advertisement delivery server 20 can recognize whether a predetermined action has been performed through a navigation element, making it possible to determine more accurately whether the target user is interested in the advertising information at an earlier time after advertisement delivery.

More specifically, the navigation elements may include at least one of a schedule registration guiding element, a routing assistance guiding element, and a web browsing guiding element. The schedule registration guiding element, which uses the scheduler function of the user terminal 40, guides the user to register a schedule for visiting an advertisement related facility. The routing assistance guiding element, which uses the routing assistance function of the user terminal 40, guides the user to the assistance of routing to an advertisement related facility. The web browsing guiding element, which uses the browser function of the user terminal 40, guides the user to browse a web page related to the advertising information.

As described above, the advertisement delivery server 20 (user terminal 40) allows the user to perform a specific action on the user terminal 40 through a specific navigation element (schedule registration guiding element, routing assistance guiding element, and web browsing guiding element).

For example, in the comparative example in which the navigation elements are not included in the advertising information as shown in FIG. 7A, the advertisement delivery system can only recognize whether the user has opened the pushed advertising information and whether the user has actually used the coupon included in the advertising information. Therefore, though this advertisement delivery system can recognize at a relatively early time after delivery whether the user has opened the advertising information, it is highly likely that the user has opened, but is not interested in, the advertising information. In this case, it is impossible to clearly determine whether the user is interested in the advertising information. In addition, though it can be determined to some extent whether the user is interested in the advertising information based on whether the coupon is used, this advertisement delivery system cannot make this determination until the user has actually used the coupon after the delivery of advertising information.

On the other hand, the advertisement delivery system 1 in this embodiment can recognize, after advertisement delivery, whether the user takes a predetermined action (such as schedule registration, routing assistance, and web browsing) related to the advertising information through the navigation elements included in the advertising information, as shown in FIG. 7B. In this case, a user's action (such as schedule registration, routing assistance, or web browsing) on the user terminal 40 indicates that the user has some interest in the advertising information. Therefore, at a relatively early time after advertisement delivery, the advertisement delivery system 1 can determine with higher accuracy whether the user is interested in the advertising information. In addition, the advertisement delivery system 1 can recognize whether the user is interested in the advertising information at a relatively early time after advertisement delivery, more specifically, before the coupon is used. This means that the advertisement delivery system 1 can provide an opportunity to deliver additional advertising information (for example, upgraded coupon), provided from the same advertiser, to the users who are interested in the advertising information. When such an opportunity is given, even more customers will visit the shop. In this way, the advertisement delivery system 1 can further improve the effect of delivering advertising information.

In this embodiment, when an operation on the routing assistance guiding element corresponding to one piece of advertising information is performed while the user is traveling to a predetermined destination and when an advertisement related facility corresponding to the one piece of advertising information is found around the current travel route to the destination, the advertising information delivery unit 204 (advertising information display processing unit 401) may suggest the advertisement related facility to the user through the user terminal 40 as a waypoint. When an advertisement related facility corresponding to the one piece of advertising information is not found around the current travel route, the advertising information delivery unit 204 may suggest an advertisement related facility, located around the current travel route and corresponding to another piece of advertising information whose genre is the same as or similar to the genre of the one piece of advertising information, to the user through the user terminal 40 as a waypoint.

As a result, when an operation on the navigation element (routing assistance guiding element) for using the routing assistance function for a facility related to one piece of advertising information is performed, the advertisement delivery server 20 (the user terminal 40) can suggest an advertisement related facility, located at an easy-to-access location while traveling to the destination and corresponding to the one piece of advertising information, as a waypoint on the current travel route. In addition, even when an advertisement related facility corresponding to the one piece of advertising information is not found around the current travel route, the advertisement delivery server 20 (user terminal 40) can suggest an advertisement related facility, corresponding to another piece of advertising information in which the user was interested in the past and whose genre is the same as or a similar to the genre of the one piece of advertising information, as a waypoint around the user's current travel route. Therefore, the advertisement delivery server 20 can improve user convenience.

In this embodiment, when an operation on the routing assistance guiding element corresponding to one piece of advertising information is performed while the user is traveling to the destination and when an advertisement related facility corresponding to the one piece of advertising information is found along the current travel route, the advertising information delivery unit 204 (advertising information display processing unit 401) may suggest the advertisement related facility to the user through the user terminal 40 as a waypoint. When an advertisement related facility corresponding to the one piece of advertising information is not found along the current travel route, the advertising information delivery unit 204 may suggest an advertisement related facility, located along another travel route to the destination around the travel route and corresponding to the one piece of advertising information, to the user through the user terminal 40 as a waypoint.

As a result, even when an advertisement related facility corresponding to the one piece of advertising information is not found along the current travel route when suggesting the advertisement related facility around the current travel route to the destination, the advertisement delivery server 20 (the user terminal 40) can suggest an advertisement related facility located along another route around the current travel route and corresponding to the one piece of the advertising information. Therefore, the advertisement delivery server 20 can further improve user convenience.

In this embodiment, the advertising information delivery unit 204 (advertising information display processing unit 401) may determine an advertisement related facility corresponding to at least one of routing assistance and schedule registration based on the information related to the travel history of the user.

As a result, the advertisement delivery server 20 (the user terminal 40) can recognize the user's past travel routes and the activity range based on the information on the user's travel history. Therefore, the advertisement delivery server 20 (the user terminal 40) can determine an advertisement related facility corresponding to schedule registration and routing assistance, which is performed based on an operation on the navigation elements included in the advertising information, according to the user's travel routes and the activity range. Therefore, the advertisement delivery server 20 can improve user convenience.

In this embodiment, the advertising information delivery unit 204 may deliver advertising information, which is displayed on the display device 46 of the user terminal 40, to the user by a predetermined method.

As a result, the advertisement delivery server 20 can cause the display device 46 of the user terminal 40 to display advertising information, in which the navigation elements are included, by delivering the advertising information to the user in a manner that the user can view it on the user terminal 40.

In place of or in addition to pushing advertising information directly to the user terminal 40 using the advertising application installed in the user terminal 40, the advertising information delivery unit 204 may use another method to deliver the advertising information to the user. For example, the advertising information delivery unit 204 may deliver advertising information to the email address or the social networking service (SNS) account of the user.

In this embodiment, the log information acquisition unit 205 (the log information sending unit 405) may acquire log information indicating whether a predetermined action is performed by the user at the user terminal 40 through a navigation element included in advertising information.

As a result, the advertisement delivery server 20 (the user terminal 40) can specifically recognize whether a predetermined action has been performed by the user through a navigation element of the advertising information displayed on the user terminal 40.

In this embodiment, the effect verification unit 207 may verify the effect of the delivery of advertising information based on the log information acquired by the log information acquisition unit 205.

As a result, the advertisement delivery server 20 can verify the effect of delivered advertising information by recognizing, based on the log information, whether each target user has performed a predetermined action through a navigation element.

While the embodiments of the present disclosure have been described in detail, it is to be understood that the present disclosure is not limited to the specific embodiments above but that various modifications and changes may be added within the spirit of the present disclosure described in claims.

What is claimed is:

1. An information processing device comprising a control unit configured to cause a display device of a user terminal to display advertising information that includes navigation elements, each of the navigation elements guiding a user to a predetermined action related to content thereof.

2. The information processing device according to claim 1, wherein
the navigation elements include at least one of a first element, a second element, and a third element, the first element guiding the user to schedule registration for a visit to a facility related to the advertising information using a scheduler function of the user terminal, the second element guiding the user to routing assistance for assisting in routing to a facility related to the advertising information using a routing assistance function of the user terminal, the third element guiding the user to browse a web page related to the advertising information using a browser function of the user terminal.

3. The information processing device according to claim 2, wherein
the control unit is configured to, when the second element corresponding to one piece of the advertising information is operated while the user is traveling to a predetermined destination:
suggest the facility to the user through the user terminal as a waypoint when a facility related to the one piece of the advertising information is found around a travel route to the destination; and
suggest another facility to the user through the user terminal as a waypoint when a facility related to the one piece of the advertising information is not found around the travel route, the other facility being located around the travel route and related to another piece of the advertising information whose genre is the same as or similar to the genre of the one piece of the advertising information.

4. The information processing device according to claim 3, wherein
the control unit is configured to, when the second element corresponding to one piece of the advertising information is operated while the user is traveling to the destination:
suggest the facility to the user through the user terminal as a waypoint when a facility related to the one piece of the advertising information is found along the travel route; and
suggest another facility to the user through the user terminal as a waypoint when a facility related to the one piece of the advertising information is not found along the travel route, the other facility being located along another travel route to the destination around the travel route and related to the one piece of the advertising information.

5. The information processing device according to claim 2, wherein
the control unit is configured to determine a facility related to the advertising information corresponding to at least one of the schedule registration and the routing assistance based on information on a travel history of the user.

6. The information processing device according to claim 1, wherein
the control unit is configured to deliver to the user the advertising information to be displayed on the display device of the user terminal by a predetermined method.

7. The information processing device according to claim 1, further comprising
a log information acquisition unit configured to acquire log information indicating whether the predetermined action has been performed by the user at the user terminal through the navigation elements.

8. The information processing device according to claim 7, further comprising
a verification unit configured to verify an effect of the delivery of the advertising information based on the log information acquired by the log information acquisition unit.

9. An information processing method executed by an information processing device, the information processing method comprising causing a display device of a user terminal to display advertising information that includes navigation elements, each of the navigation elements guiding a user to a predetermined action related to content thereof.

10. A program causing an information processing device to cause a display device of a user terminal to display advertising information that includes navigation elements, each of the navigation elements guiding a user to a predetermined action related to content5 thereof.
